(19) United States
(12) Patent Application Publication
(10) Pub. No.: US 2017/0202383 A1
(43) Pub. Date: Jul. 20, 2017

(54) ELEVATED UTENSIL

(71) Applicant: Yi Liang Yew, Ames, IA (US)

(72) Inventor: Yi Liang Yew, Ames, IA (US)

(21) Appl. No.: 15/405,866

(22) Filed: Jan. 13, 2017

Related U.S. Application Data
(60) Provisional application No. 62/278,517, filed on Jan. 14, 2016.

(51) Int. Cl. A47G 21/02; A47G 21/04; B26B 3/02

(52) U.S. Cl. CPC A47G 21/023; B26B 3/02; A47G 21/04

(57) ABSTRACT

An elevated utensil includes a handle, an angled section, and a working section, and is configured to hold the working section in an elevated position, such that it does not contact a working surface. The working section can be any useful device capable of performing tasks.

### CROSS REFERENCE TO RELATED APPLICATION

This application claims the benefit of U.S. Provisional Application No. 62/278,517 filed Jan. 14, 2016.

### BACKGROUND OF THE INVENTION

This invention is directed toward a utensil, and more particularly to an elevated utensil.

Utensils are well-known in the art and come in many shapes, sizes and styles such as eating utensils and cleaning utensils. While utensils each have a different purpose, common to all is a gripping section and a working section. In some examples, the working section not only comes into contact with food or surfaces, but also is received within an individual's mouth.

Sometimes during the course of use, it is necessary to place a utensil down on a surface. When this occurs, several things can happen. First, if there are particles on the utensil, these particles can be transferred to the surface. Second, if the surface has not been properly cleaned, dirt, debris, and bacteria may be transferred to the utensil. Third, there are times where one desires that the working section be raised from a surface.

Thus, it is a primary objective to provide a utensil that improves upon the art.

Another objective of this invention is to provide an elevated utensil that maintains a sanitary working section.

Yet another objective of this invention is to provide an elevated utensil that keeps a surface clean when the utensil is placed on it.

Another objective of this invention is to provide a utensil that is self-elevating, in order to maintain hygiene as simply and intuitively as possible.

Yet another objective of this invention is to provide an elevated utensil made of a single, homogenous material.

These and other objectives, features, and advantages of the invention will become apparent from the specification and claims.

### SUMMARY OF THE INVENTION

An elevated utensil having an elongated member with a first and a second end. Adjacent the second end the elongated member has a surface contact section formed to engage a working surface. The surface contact section extends from the second end and terminates in an angled section that is angled upwardly away from the working surface and terminates in a neck.

A working section of the elongated member extends from the first end and terminates in the neck. The surface contact section is configured to have a center of gravity that provides a downward force that holds the angled section and the working, section in a raised position where the angled section and the working section do not contact the working surface.

### BRIEF DESCRIPTION OF THE DRAWINGS

FIG. 1 is a perspective view of an elevated utensil;

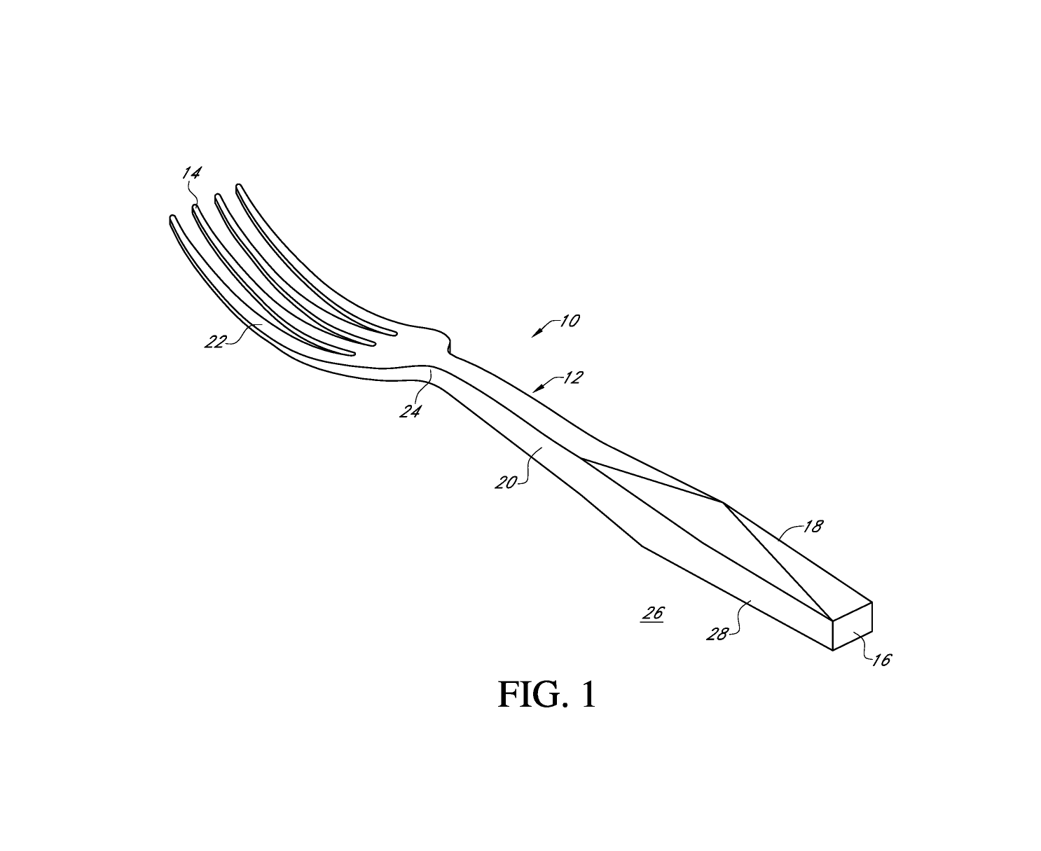

FIG. 2 is a top view of an elevated utensil; and

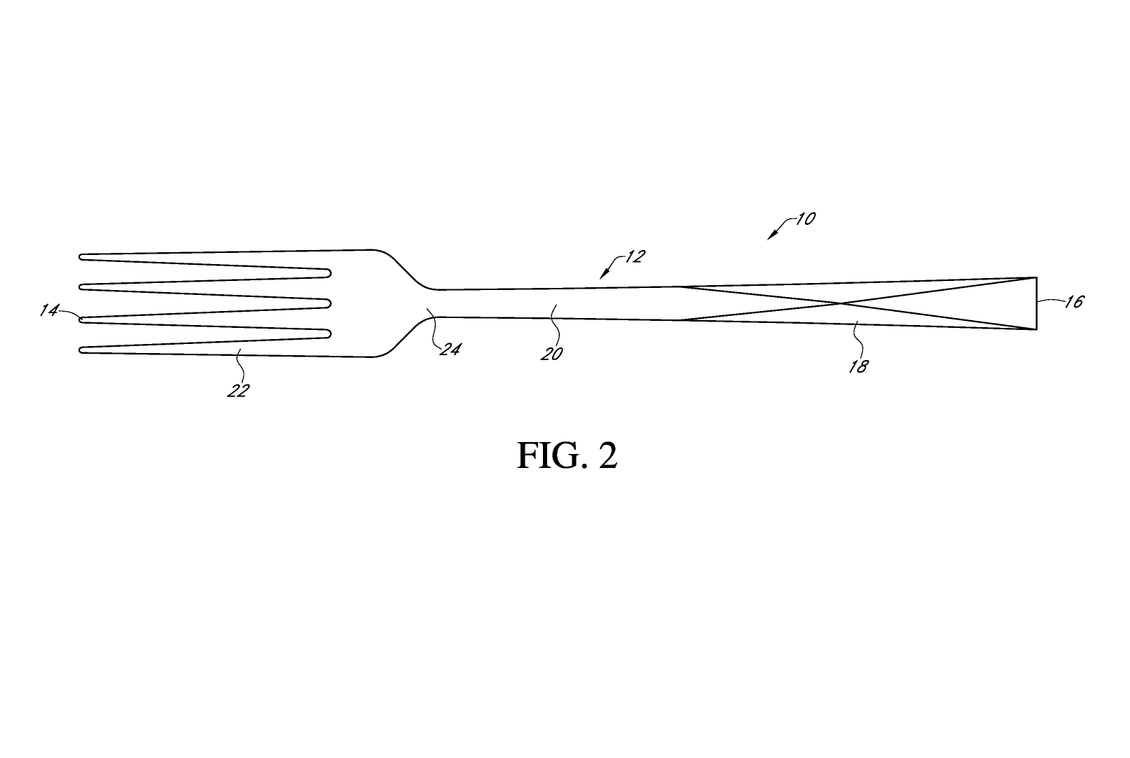

FIG. 3 is a side view of an elevated utensil.

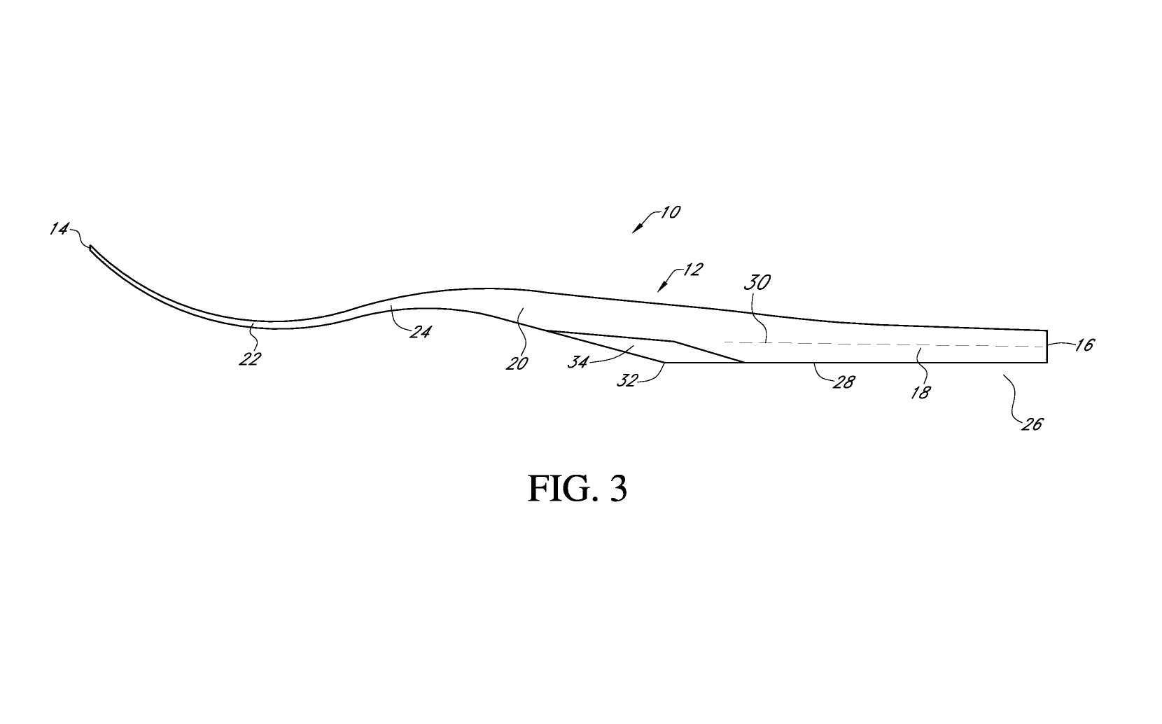

### DETAILED DESCRIPTION OF THE PREFERRED EMBODIMENT

Referring to the Figures, an elevated utensil 10 is presented. In the arrangement shown, elevated utensil 10 includes an elongated member 12 having a first end 14 and a second end 16. For purposes of example only, an eating utensil is described, but the elevated utensil 10 is not limited by this example. The term utensil is defined to mean any useful device used to perform tasks

The elongated member 12 is comprised of a surface contact section 18, an angled section 20, and a working section 22. In one embodiment, elongated member 12 is made of a single, homogenous material. Elongated member 12 can be formed from any material that is suitable for its intended purpose.

The surface contact section 18 is adjacent to the second end 16 and terminates into the angled section 20. Surface contact section 18 is formed of any suitable size, shape, and design and serves to engage the surface, in addition to being grasped and held by a user while the utensil is being used. In one embodiment, surface contact section 18 is a generally elongated shape, such as a rectangle, that gets slightly wider as it extends from angled section 20 towards second end 16. However, any other suitable shape, size, and design is hereby contemplated for use for surface contact section 18.

Angled section 20 extends upwardly from surface contact section 18 and terminates at neck 24. In one embodiment, angled section 20 is a generally elongated shape, such as a rectangle, that narrows slightly as it extends from surface contact section 18 towards neck 24. However, any other suitable shape, size, and design is hereby contemplated for use for angled section 20.

Neck 24 connects angled section 20 with working section 22. Neck 24 is formed of any suitable size, shape, and design that serves to connect angled section 20 with working section 22. In the embodiment shown, neck 24 narrows at its middle and is wider at its ends where it connects to angled section 20 and working section 22. However, any other suitable size, shape, and design is hereby contemplated for use for neck 24.

The working section 22 is adjacent the first end 14 and is of any size, shape, and design that is suitable for its designated function. In one embodiment, the working section is that of an eating utensil, such as a bowl of a spoon, prongs of a fork, a blade of a knife, or the like. The working section 22 terminates into the angled section 20 at a neck 24.

While the surface contact section 18 is of any size and shape, the surface contact section 18 has a bottom surface 28 that engages a working surface 26. The working surface 26 can be an eating surface such as a table or counter, or any other surface where the utensil 10 is used. The bottom surface 28 extends from the second end 16 to the point where the elongated member 12 transitions from section 18 to angled section 20 at transition point 32. The length of the bottom surface 28 is based on the weight of the surface contact section 18 compared to the weight of the angled section 20 and the working section 22. Based on this weight comparison, the length of the bottom surface 28 need be sufficient to create a center of gravity that creates a down force in the contact surface section 18 that causes the angled section 20 and working section 22 to be held in a raised or elevated position above the center line 30 of the surface contact section 18. If desired, a weight 34 is inserted or attached to the surface contact section 18.

From the above discussion and the accompanying figures and claims it will be appreciated that the utensil 10 offers many advantages over the prior art. That is, the utensil 10 provides a working section that is capable of remaining elevated after it is placed on surface, as well as many other advantages and improvements over the prior art. It will be appreciated by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included within the spirit and purview of this application.

What is claimed is:

1. An elevated utensil, comprising:
an elongated member having a first end and a second end;
a surface contact section of the elongated member is adjacent the second end and terminates into an angled section; and
a working section of the elongated member adjacent the first end that terminates in the angled section and is elevated above a center line of the surface contact section.

2. The utensil of claim 1 wherein a neck is positioned between the working section and the angled section of the elongated member.

3. The utensil of claim 1 wherein the surface contact section has a bottom surface having a length with a center of gravity that provides a downforce that holds the angled section and the working section in a raised position.

4. The utensil of claim 1 wherein the working section is selected from a group consisting of:
the prongs of a fork, the bowl of a spoon, and the blade of a knife.

5. The utensil of claim 1 wherein the surface contact section has a flat, planar bottom surface configured to engage with a working surface.

6. The utensil of claim 1 wherein the surface contact section has a weight.
